(19) United States
(12) Patent Application Publication
(10) Pub. No.: US 2011/0285871 A1
(43) Pub. Date: Nov. 24, 2011

(54) IMAGE PROCESSING APPARATUS, IMAGE PROCESSING METHOD, AND COMPUTER-READABLE MEDIUM

(75) Inventor: Hiroyuki Sakai, Chigasaki-shi (JP)

(73) Assignee: CANON KABUSHIKI KAISHA, Tokyo (JP)

(21) Appl. No.: 12/964,270

(22) Filed: Dec. 9, 2010

(30) Foreign Application Priority Data
May 24, 2010 (JP) 2010-118773

(51) Int. Cl. H04N 5/235

(52) U.S. Cl. 348/229.1; 348/E05.037

(57) ABSTRACT

An image processing apparatus comprises a determination unit which determines whether exposure of an input image is correct; a generation unit which generates a low-frequency image for locally changing a correction amount of brightness for the input image when the determination unit determines that the exposure of the input image is incorrect; a correction unit which corrects brightness of the input image by using the low-frequency image; a holding unit which holds a plurality of filters including at least a low-pass filter and a high-pass filter; and a filter processing unit which performs filter processing for a target pixel of an image corrected by the correction unit while locally changing at least types of the plurality of filters or a correction strength based on a correction amount of brightness using the low-frequency image.

### BACKGROUND OF THE INVENTION

1. Field of the Invention

The present invention relates to an image processing apparatus which corrects noise worsened in input digital image data after image correction, an image processing method, and a computer-readable medium.

2. Description of the Related Art

Conventionally, there have been proposed many apparatuses and methods which print suitable photographic images by performing various corrections for photographic image data captured by digital cameras. Such image correction methods fall into the general classification of uniform correction methods of performing uniform correction for an entire image and local correction methods of changing a correction amount in accordance with the local property of an image. Among these local correction methods, a typical one is dodging correction for exposure. Dodging correction is performed as follows. When, for example, an object such as a person is dark and the background is bright, the lightness of the dark person region is greatly increased, and the luminance of the bright background is not changed much. This operation suppresses a highlight detail loss in the background and properly corrects the brightness of the person region. As an example of dodging correction, there is available a technique of implementing dodging correction for a digital image by performing filter processing for an input image to generate a low-frequency image, that is, a blurred image, and using the blurred image as a control factor for brightness.

A dodging correction technique can locally control brightness, and hence can increase the dark region correction amount as compared with a technique using one tone curve. In contrast to this, this technique greatly worsens dark region noise. With regard to this problem, Japanese Patent Laid-Open No. 2006-65676 discloses a method of removing a worsened noise component when performing local brightness correction by the dodging processing of a frame captured by a network camera.

The above method of removing worsened noise after dodging correction has the following problem. The method disclosed in Japanese Patent Laid-Open No. 2006-65676 extracts the luminance component of an image, performs dodging processing by using a luminance component blurred image, and removes high-frequency noise in a dark region by using a blur filter such as a low-pass filter in accordance with a local brightness/darkness difference correction amount. However, since this technique uses only a blur filter such as a low-pass filter, the overall image looks blurred.

Especially when controlling noise removal processing in accordance with the control amount of dodging correction, dodging processing blurs a dark region, in particular, because a large correction amount is set for the dark region. Even if, for example, a dark region of an image includes an edge, other than noise, which is not desired to be blurred, the above processing generates a blurred image as a whole. In addition, the noise removal method uses a median filter or low-pass filter to remove high-frequency noise in a dark region, and hence cannot remove low-frequency noise worsened by dodging correction processing.

### SUMMARY OF THE INVENTION

According to one aspect of the present invention, there is provided an image processing apparatus comprising: a determination unit which determines whether exposure of an input image is correct; a generation unit which generates a low-frequency image for locally changing a correction amount of brightness for the input image when the determination unit determines that the exposure of the input image is incorrect; a correction unit which corrects brightness of the input image by using the low-frequency image; a holding unit which holds a plurality of filters including at least a low-pass filter and a high-pass filter; and a filter processing unit which performs filter processing for a target pixel of an image corrected by the correction unit while locally changing at least types of the plurality of filters or a correction strength based on a correction amount of brightness using the low-frequency image, wherein the filter processing unit increases correction strength of the low-pass filter in the filter processing as the correction amount of brightness for the target pixel by the correction unit increases, and increases correction strength of the high-pass filter in the filter processing as the correction amount of brightness for the target pixel by the correction unit decreases.

According to another aspect of the present invention, there is provided an image processing apparatus comprising: a determination unit which determines whether exposure of an input image is correct; a generation unit which a low-frequency image for locally changing a correction amount of brightness for the input image when the determination unit determines that the exposure of the input image is incorrect; a correction unit which corrects brightness of the input image by using the low-frequency image; an edge determination unit which detects an edge determination amount indicating a strength of an edge in one of the input image and an image whose brightness has been corrected by the correction unit; a holding unit which holds a plurality of filters including at least a low-pass filter and a high-pass filter; and a filter processing unit which performs filter processing for a target pixel of an image corrected by the correction unit while locally changing at least types of the plurality of filters or a correction strength by using a correction amount of brightness using the low-frequency image and the edge determination amount, wherein the filter processing unit increases correction strength of the low-pass filter in the filter processing as the correction amount of brightness for the target pixel by the correction unit increases and the edge determination amount decreases, and increases correction strength of the high-pass filter in the filter processing as the correction amount of brightness for the target pixel by the correction unit increases and the edge determination amount increases.

According to another aspect of the present invention, there is provided an image processing method comprising: a determination step of causing a determination unit to determine whether exposure of an input image is correct; a generation step of causing a generation unit to generate a low-frequency image for locally changing a correction amount of brightness for the input image when it is determined in the determination step that the exposure of the input image is incorrect; a correction step of causing a correction unit to correct brightness of the input image by using the low-frequency image; and a filter processing step of causing a filter processing unit to perform filter processing for a target pixel of an image corrected in the correction step while locally changing at least types of the plurality of filters including at least a low-pass filter and a high-pass filter or a correction strength based on a correction amount of brightness using the low-frequency image, wherein in the filter processing step, a correction strength of the low-pass filter in the filter processing increases as the correction amount of brightness for the target pixel in the correction step increases, and a correction strength of the high-pass filter in the filter processing increases as the correction amount of brightness for the target pixel in the correction step decreases.

According to another aspect of the present invention, there is provided an image processing method comprising: a determination step of causing a determination unit to determine whether exposure of an input image is correct; a generation step of causing a generation unit to generate a low-frequency image for locally changing a correction amount of brightness for the input image when it is determined in the determination step that the exposure of the input image is incorrect; a correction step of causing a correction unit to correct brightness of the input image by using the low-frequency image; an edge determination step of causing an edge determination unit to detect an edge determination amount indicating a strength of an edge in one of the input image and an image whose brightness has been corrected in the correction step; and a filter processing step of causing a filter processing unit to perform filter processing for a target pixel of an image corrected in the correction step while locally changing at least types of the plurality of filters including at least a low-pass filter and a high-pass filter or a correction strength by using a correction amount of brightness using the low-frequency image and the edge determination amount, wherein in the filter processing step, a correction strength of the low-pass filter in the filter processing increases as the correction amount of brightness for the target pixel in the correction step increases and the edge determination amount decreases, and a correction strength of the high-pass filter in the filter processing increases as the correction amount of brightness for the target pixel in the correction step increases and the edge determination amount increases.

It is possible to remove worsened noise without affecting a region which is not corrected by dodging correction while reducing the sense of blurring of the overall image which occurs when performing noise removal using a low-pass filter or the like in accordance with the control amount of dodging correction processing. In particular, it is possible to remove noise without blurring an edge portion which exists in a dark region of an image and is not desired to be blurred. In addition, it is possible to remove worsened high-frequency noise and low-frequency noise without affecting a region which is not corrected by dodging correction.

Further features of the present invention will become apparent from the following description of exemplary embodiments (with reference to the attached drawings).

### BRIEF DESCRIPTION OF THE DRAWINGS

FIG. 1 is a block diagram for the basic processing of the present invention;

FIG. 2 is a block diagram showing a hardware arrangement according to the present invention;

FIG. 3 is a flowchart showing the processing performed by a low-frequency image generation unit 102 according to the present invention;

FIG. 4 is a view for explaining low-frequency image generation according to the present invention;

FIG. 5 is a flowchart showing dodging correction processing according to the present invention;

FIG. 6 is a flowchart showing noise removal as the basic processing of the present invention;

FIG. 7 is a block diagram showing processing according to the first embodiment;

FIG. 8 is a flowchart showing noise removal according to the first embodiment;

FIG. 9 is a graph for explaining filter switching control according to the first embodiment;

FIG. 10 is a block diagram for processing according to the second embodiment;

FIG. 11 is a view for explaining edge determination according to the second embodiment;

FIG. 12 is a flowchart showing noise removal according to the second embodiment;

FIG. 13 is a graph for explaining the calculation of an emphasis coefficient J according to the second embodiment;

FIG. 14 is a graph for explaining the calculation of a flatness coefficient M according to the second embodiment;

FIG. 15 is a block diagram for processing according to the third embodiment;

FIG. 16 is a flowchart showing noise removal according to the third embodiment;

FIG. 17 is a view for explaining pixel replace processing according to the third embodiment; and

FIG. 18 is a flowchart showing processing in an exposure correctness determination unit 101 according to the present invention.

### DESCRIPTION OF THE EMBODIMENTS

### First Embodiment

### Explanation of Hardware Arrangement

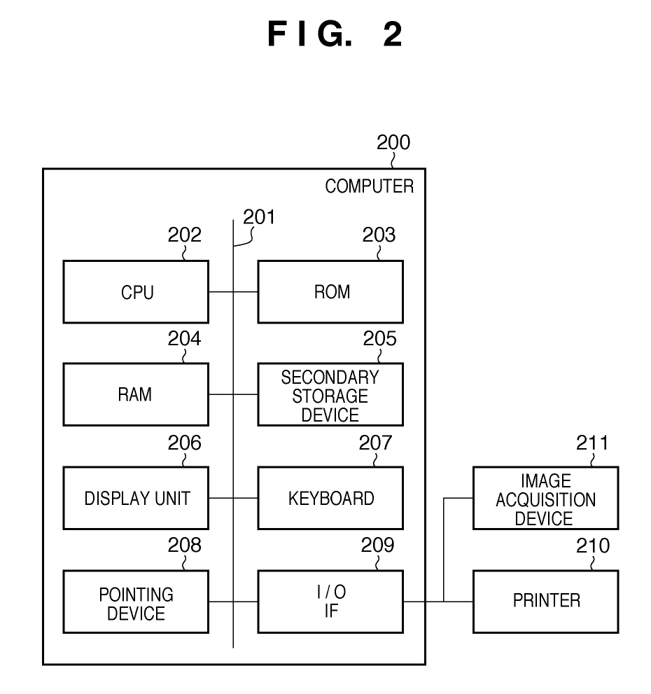

FIG. 2 shows a hardware arrangement which can execute an image processing method of the present invention. Note that FIG. 2 shows an example in this embodiment. The present invention is not limited to the arrangement shown in FIG. 2. The hardware arrangement of this embodiment includes a computer 200 and a printer 210 and image acquisition device 211 (for example, a digital camera or scanner) which are connected to the computer 200. In the computer 200, a CPU 202, a ROM 203, a RAM 204, and a secondary storage device 205 such as a hard disk are connected to a system bus 201.

In addition, a display unit 206, a keyboard 207, and a pointing device 208 are connected as user interfaces to the CPU 202 and the like. Furthermore, the computer 200 is connected to the printer 210 via an I/O interface 209. The computer 200 is also connected to the image acquisition device 211 via the I/O interface 209. Upon receiving an instruction to execute an application (a function of executing the processing to be described below), the CPU 202 reads out a program installed in a storage unit such as the secondary storage device 205 and loads the program into the RAM 204. Executing the program thereafter can execute the designated processing.

(Explanation of Overall Processing Procedure)

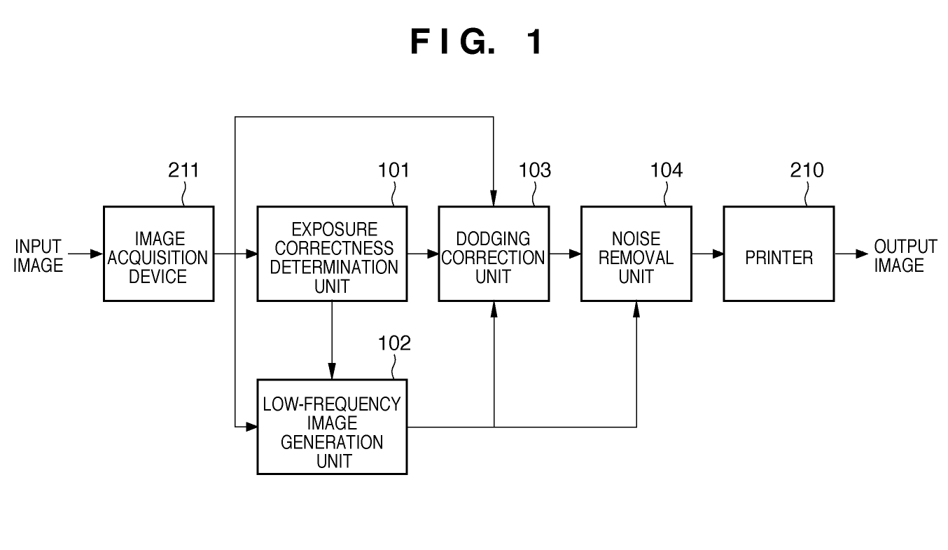

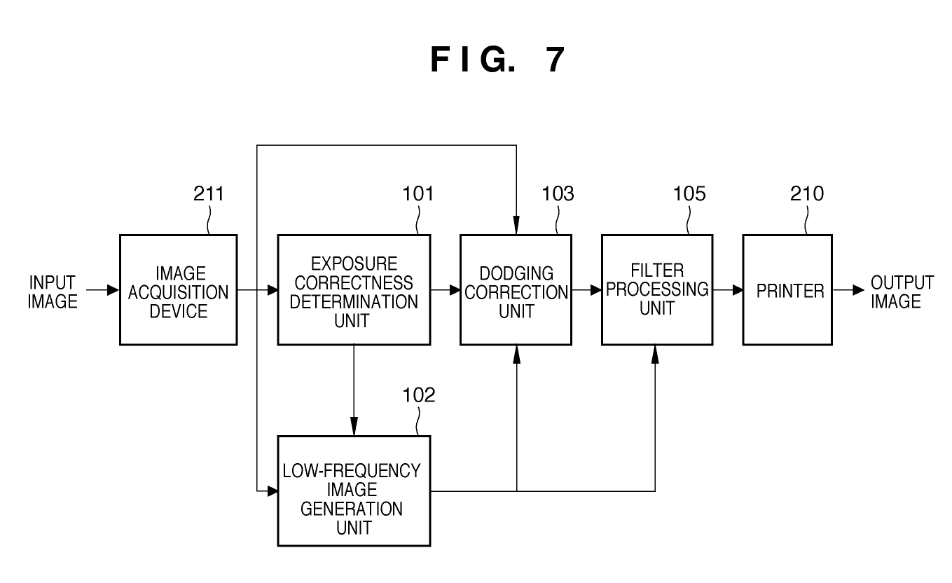

FIG. 1 is a block diagram for the basic processing of this embodiment. The detailed features of processing according to this embodiment will be described later with reference to FIG. 7. Before this description, an overall processing procedure as a basic procedure according to this embodiment of the present invention will be described. A processing procedure will be described below with reference to FIG. 1. Processing in each processing unit will be described in detail with reference to a flowchart as needed.

First of all, this apparatus acquires digital image data which is captured by a digital camera, which is the image acquisition device 211, and stored in a recording medium such as a memory card. The apparatus then inputs the acquired digital image data as an input image to an exposure correctness determination unit 101. Although a digital camera is exemplified as the image acquisition device 211, the device to be used is not limited to this, and any device can be used as long as it can acquire digital image data.

For example, it is possible to use, as the image acquisition device 211, a scanner or the like which acquires digital image data by reading an image on a film which is captured by an analog camera. Alternatively, it is possible to acquire digital image data from a storage medium in a server connected to the apparatus via a network. The format to be used for input image data is not specifically limited for the application of the present invention. For the sake of simplicity, however, assume that each pixel value of image data is composed of an RGB component value (each component is composed of 8 bits).

(Exposure Correctness Determination)

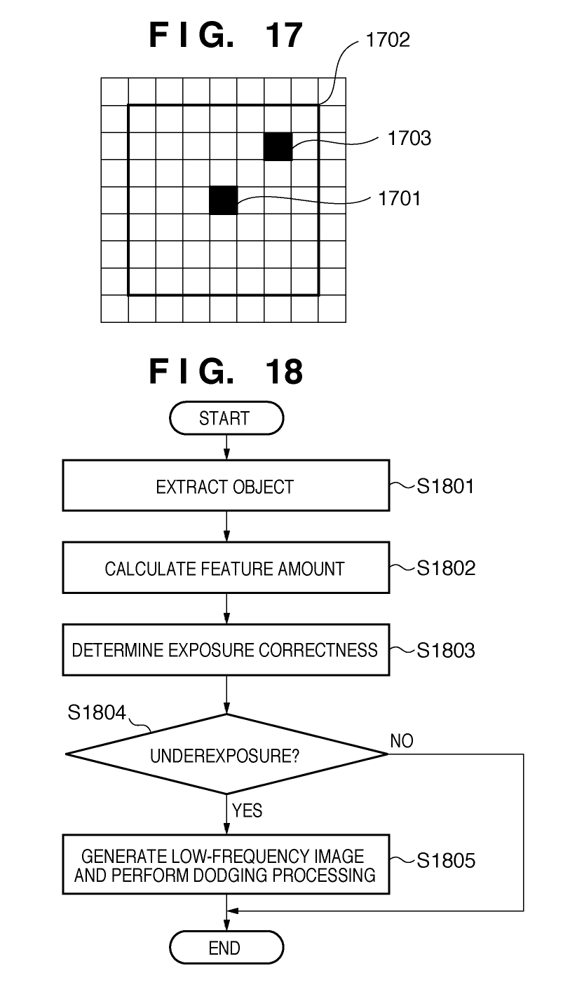

The exposure correctness determination unit 101 then performs exposure correctness determination by performing image analysis processing from the input image data. FIG. 18 is a flowchart of processing by the exposure correctness determination unit 101. According to the flowchart of exposure correctness determination, first of all, in step S1801, the exposure correctness determination unit 101 performs the object extraction processing of extracting a main object (for example, the face of a person) from the input image. Note that various known references have disclosed main object extraction processing, and it is possible to use any technique as long as it can be applied to the present invention. For example, the following techniques can be applied to the present invention.

According to Japanese Patent Laid-Open No. 2002-183731, an eye region is detected from an input image, and a region around the eye region is set as a candidate face region. This method calculates a luminance gradient and luminance gradient weight for each pixel with respect to the candidate face region. The method then compares the calculated values with the gradient and gradient weight of a preset ideal reference face image. If the average angle between the respective gradients is equal to or less than a predetermined threshold, the method determines that the input image has a face region.

In addition, Japanese Patent No. 3557659 discloses a technique of calculating the matching degree between templates representing a plurality of face shapes and an image. This technique then selects a template exhibiting the highest matching degree. If the highest matching degree is equal to or more than a predetermined threshold, the technique sets a region in the selected template as a candidate face region.

In additions, as methods of detecting faces and organs, various techniques have been proposed in, for example, Japanese Patent Laid-Open Nos. 8-77334 and 2001-216515, Japanese Patent No. 2973676, Japanese Patent Laid-Open Nos. 11-53525, 2000-132688, and 2000-235648 and Japanese Patent Nos. 3549013 and 2541688.

In step S1802, the exposure correctness determination unit 101 performs feature amount analysis on the main object region of the input image data to determine the underexposure status of the extracted main object. For example, this apparatus sets a luminance average and a saturation distribution value as references for the determination of underexposure images in advance. If the luminance average and the saturation variance value are larger than the preset luminance average and saturation distribution value, the exposure correctness determination unit 101 determines that this image is a correct exposure image. If the average luminance and the saturation variance value are smaller than the present values, the exposure correctness determination unit 101 determines that the image is an underexposure image. Therefore, the exposure correctness determination unit 101 calculates an average luminance value Ya and a saturation variance value Sa of the main object as feature amounts of the image.

In step S1803, the exposure correctness determination unit 101 compares the calculated feature amount of the image with a preset feature amount to determine an underexposure status. For example, this apparatus sets a reference average luminance value Yb and reference saturation variance value Sb of the main object in advance. If the calculated average luminance value Ya is smaller than the reference average luminance value Yb and the calculated saturation variance value Sa of the main object is smaller than the reference saturation variance value Sb, the exposure correctness determination unit 101 determines that underexposure has occurred.

It is possible to perform exposure correctness determination by using any method as long as it can determine exposure correctness. For example, it is possible to set, as an underexposure image, an image which is bright as a whole but a main object is dark, like a backlit image. In this case, the exposure correctness determination unit 101 calculates an average luminance value Yc of the overall input image data as a feature amount, and also calculates the average luminance value Ya of the extracted main object region. If the reference average luminance value Yb of the main object region is smaller than the average luminance value Yc of the overall image data, the exposure correctness determination unit 101 can determine that the image is in an underexposure state.

In addition, for example, as a method of determining whether an image is in an underexposure state, the image processing method disclosed in Japanese Patent Application No. 2009-098489 is available. According to Japanese Patent Application No. 2009-098489, the feature amount calculation unit analyzes color-space-converted image data, calculates feature amounts representing a lightness component and a color variation component, and transmits them to the scene determination unit. For example, the feature amount calculation unit calculates the average value of luminance (Y) as a lightness component and the variance value of color difference (Cb) as a color variation component.

The feature amount calculation unit calculates the average value of luminance (Y) by using the following equation:

$$average value of luminance ( Y ) = {\sum }_{0}^{255} ( luminance value ( Y ) \times frequency ) / total pixel count \qquad ( 1 )$$

The feature amount calculation unit obtains the average value of color difference (Cb) and then calculates the variance value of color difference by using equations (2) and (3) given below:

$$\begin{matrix}average value of color difference ( Cb ) = \begin{matrix}{\sum }_{0}^{255} ( color difference value ( Cb ) \times frequency ) / \\ total pixel count\end{matrix} \\ & ( 2 ) \\ variance value of color difference ( Cb ) = {\sum }_{0}^{255} ( \begin{matrix}( color difference value ( Cb ) \times \\ {average value of color differences )}^{2}\end{matrix} ) / total pixel count & ( 3 )\end{matrix}$$

The scene determination unit calculates the distances between the value obtained by combining the feature amounts calculated by the feature amount calculation unit and the representative values of combinations of a plurality of feature amounts representing the respective scenes which are set in advance. The scene determination unit then determines, as the scene of the acquired image, a scene exhibiting a representative value corresponding to the shortest distance among the calculated distances from the representative values. For example, feature amounts include the average value of luminances (Y) as the feature amount of a lightness component and the variance value of color difference (Cb) as the feature amount of a color variation component.

Likewise, a plurality of feature amounts representing the respective scenes set in advance are the average value of luminances (Y) as the feature amount of a lightness component and the variance value of color difference (Cb) as the feature amount of a color variation component. Assume that the scenes set in advance include two scenes, that is, a night scene and an underexposure scene. Assume that three representative values are held for the night scene, and three combinations of feature amounts as average values of luminances (Y) and variance values of color differences (Cb) are set in advance.

Assume that four representative values are held for the underexposure scene, and four combinations of feature amounts as average values of luminances (Y) and variance values of color differences (Cb) are set in advance. The scene determination unit calculates the differences between the combination value of the feature amounts calculated from the acquired image and the seven representative values, and calculates a representative value exhibiting the smallest difference among the seven feature amounts. The scene determination unit then determines the preset scene setting corresponding to the representative value exhibiting the smallest difference as the scene of the acquired image. Note that it is possible to use any of the above methods as long as it can determine an underexposure state.

Upon determining by the above exposure determination in step S1804 that the input image data is in a correct exposure state (NO in step S1804), the apparatus terminates this processing procedure without performing dodging processing. Note that after a general image processing procedure (not shown), the apparatus executes print processing. Upon determining that the input image data is an underexposure state (YES in step S1804), the low-frequency image generation unit 102 generates a low-frequency image in step S1805. A dodging correction unit 103 and a noise removal unit 104 then perform processing (dodging processing).

(Low-Frequency Image Generation Processing)

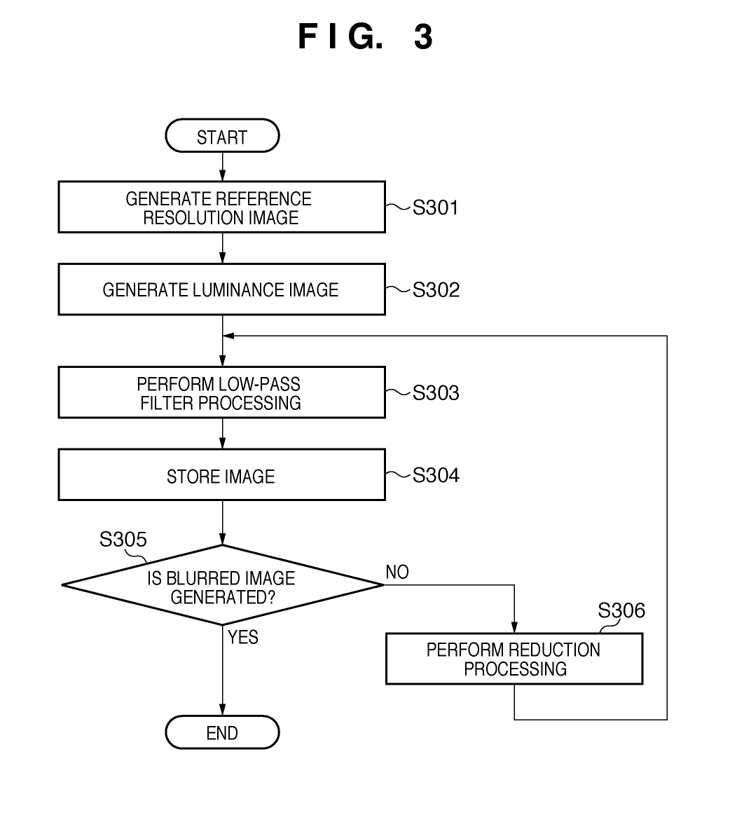

The low-frequency image generation unit 102 generates a plurality of blurred images with different degrees of blurring from input image data, and generates a low-frequency image by compositing the generated blurred images. FIG. 3 is a flowchart for the low-frequency image generation unit 102.

In the blurred image generation procedure, first of all, in step S301, the low-frequency image generation unit 102 converts the resolution of an input image (for example, an RGB color image) into a reference solution. The reference solution indicates a predetermined size. For example, the low-frequency image generation unit 102 changes the width and height of the input image to make it have an area corresponding to (800 pixels×1200 pixels). Note that methods for resolution conversion include various interpolation methods such as nearest neighbor interpolation and linear interpolation. In this case, it is possible to use any of these methods.

In step S302, the low-frequency image generation unit 102 converts the RGB color image, which has changed into the reference solution, into a luminance image by using a known luminance/color difference conversion scheme. The luminance/color difference conversion scheme used in this case is not essential to the present invention, and hence will not be described below. In step S303, the low-frequency image generation unit 102 applies a predetermined low-pass filter to the changed image data, and stores/holds the resultant low-frequency image in an area of the RAM 204 which is different from the luminance image storage area. Low-pass filters include various kinds of methods. In this case, assume that a 5×5 smoothing filter like that represented by equation (4) given below is used:

$$F = \frac{1}{25} [ \begin{matrix}1 & 1 & 1 & 1 & 1 \\ 1 & 1 & 1 & 1 & 1 \\ 1 & 1 & 1 & 1 & 1 \\ 1 & 1 & 1 & 1 & 1 \\ 1 & 1 & 1 & 1 & 1\end{matrix} ] \qquad ( 4 )$$

Note that the blurred image generation method to be used in the present invention is not limited to the smoothing filter represented by equation (4). For example, it is possible to use the coefficients of a Gaussian filter as those of the smoothing filter or may use a known IIR or FIR filter.

Upon applying blurred image generation processing to the image data by using the above filter, the low-frequency image generation unit 102 stores the resultant image in a storage unit such as the RAM 204 (S304). Subsequently, the low-frequency image generation unit 102 determines whether the blurred image generation processing is complete (S305). If the blurred image generation processing is not complete (NO in step S305), the low-frequency image generation unit 102 performs reduction processing to generate blurred images with difference degrees of blurring (S306). In step S306, the low-frequency image generation unit 102 reduces the image data processed by the low-pass filter into image data having a size corresponding to a predetermined reduction ratio (for example, ¼). The process then returns to step S303 to perform similar filter processing. The low-frequency image generation unit 102 repeats the above reduction processing and blurred image generation processing using the low-pass filter by a required number of times to generate a plurality of blurred images with different sizes.

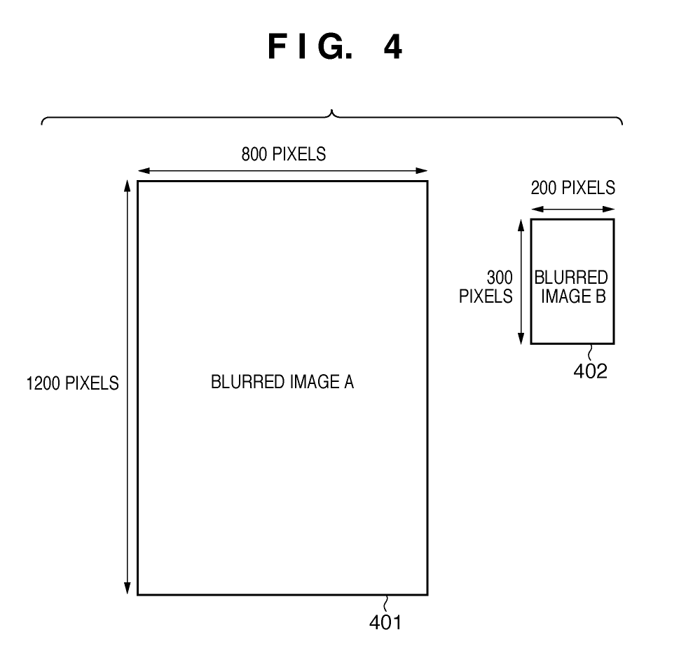

For the sake of simplicity, assume that the low-frequency image generation unit 102 has generated two blurred images having different sizes like those shown in FIG. 4 and stored them in the storage unit. The length and width of blurred image B are ¼ those of blurred image A. Since blurred image B is processed by the same filter as that used for blurred image A, resizing blurred image B to the same size as that of blurred image A will increase the degree of blurring as compared with blurred image A. The low-frequency image generation unit 102 then weights and adds two blurred images 401 and 402 with the same size to obtain a low-frequency image. In this case, the low-frequency image generation unit 102 obtains a low-frequency image by compositing low-frequency images with different cutoff frequencies as a plurality of blurred images by weighting/averaging. The method to be used is not limited to this as long as a low-frequency image can be generated from an input image.

(Dodging Processing)

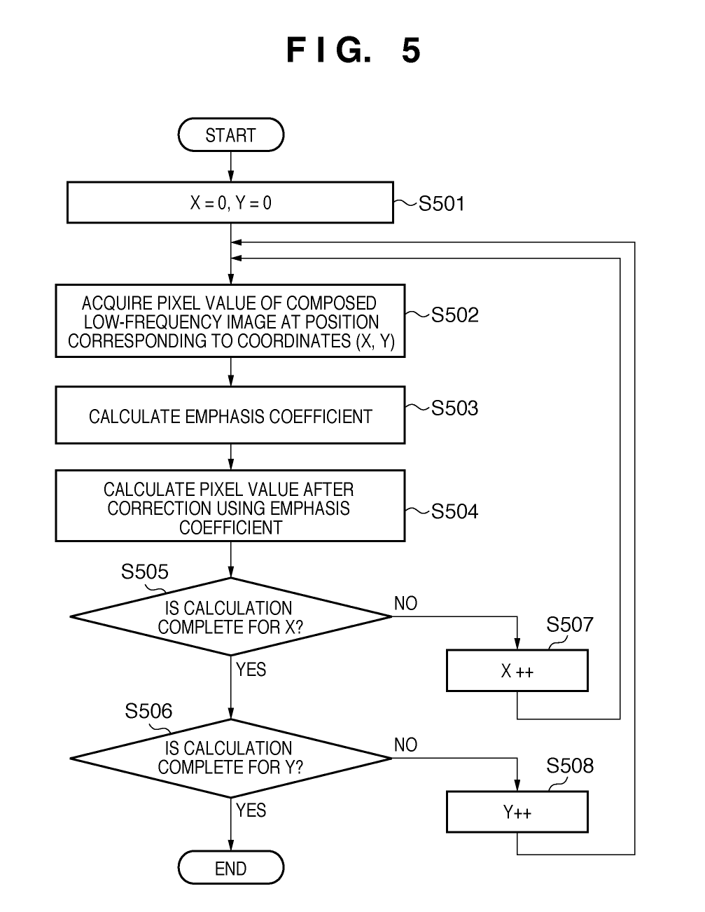

The dodging correction unit 103 then performs contrast correction processing locally for the input image by using the low-frequency image. FIG. 5 is a flowchart for dodging processing which can be applied to the present invention.

First of all, in step S501, the dodging correction unit 103 initializes the coordinate position (X, Y) indicating the coordinates of a processing target image. In step S502, the dodging correction unit 103 acquires a pixel value on the low-frequency image which corresponds to the coordinate position (X, Y). In this case, the coordinates of each pixel on the low-frequency image are represented by (Xz, Yz). Upon acquiring the pixel value at the coordinate position (Xz, Yz) on the low-frequency image, the dodging correction unit 103 calculates an emphasis coefficient K for the execution of dodging processing in step S503. It is possible to use any one of the dodging correction techniques disclosed in known references. In this case, for example, the emphasis coefficient K is determined by using the following equation:

K=g×(1.0−(B(Xz,Yz)/255)) (5)

In equation (5), B(Xz, Yz) represents a pixel value (0 to 255) of the low-frequency image at the coordinates (Xz, Yz), and g is a predetermined constant. Equation (5) indicates that the darker the low-frequency image (the smaller the pixel value), the larger the emphasis coefficient K, and the vice versa. Changing the value of each pixel of the low-frequency image can locally change the correction amount of brightness in the input image.

In step S504, the dodging correction unit 103 performs dodging correction by multiplying the pixel value of each color component of an output image by the emphasis coefficient K. If the output image holds RGB components, it is possible to multiply each of R, G, and B components by the emphasis coefficient K. For example, it is possible to convert R, G, and B components into luminance and color difference components (YCbCr) and multiply only the Y component by the emphasis coefficient.

Performing the above processing for all the pixels of the processing target image (S505 to S508) can perform dodging processing using the low-frequency image. Obviously, the present invention incorporates all cases using any dodging schemes as well as the method using an emphasis coefficient.

(Noise Removal Processing)

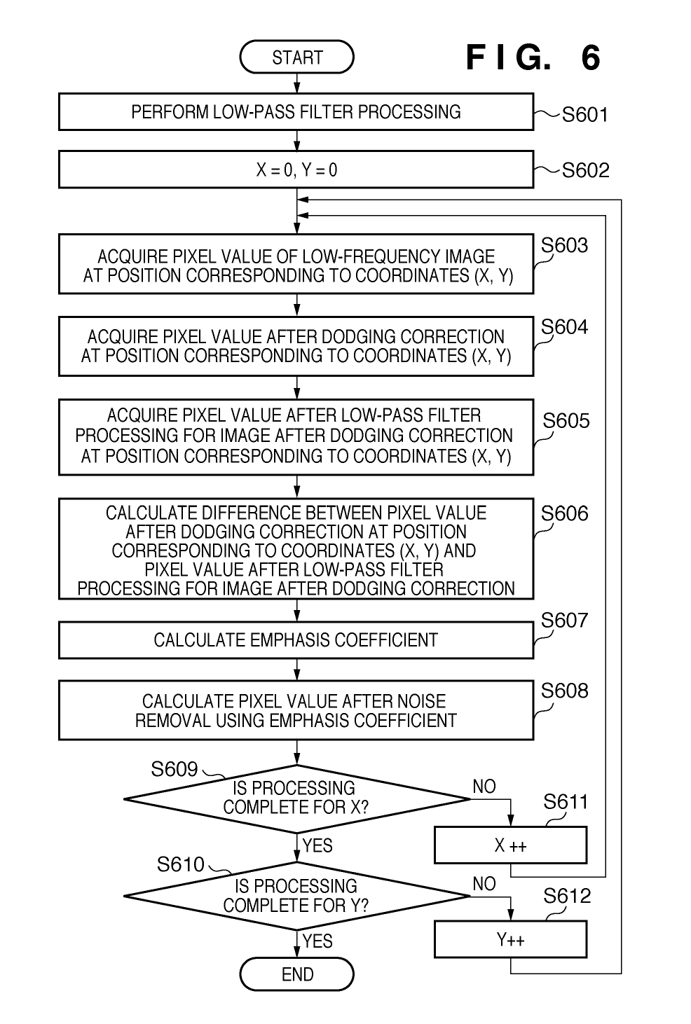

The noise removal unit 104 includes a filter processing mode. The noise removal unit 104 changes the correction strength for noise removal processing in accordance with the above low-frequency image and emphasis coefficient, and performs noise removal processing for the image after dodging correction. FIG. 6 is a flowchart for noise removal processing.

First of all, in step S601, the noise removal unit 104 performs low-pass filter processing for the entire image after dodging correction and stores the resultant image in the storage unit. In this case, the noise removal unit 104 performs low-pass filter processing as a noise removal method. However, it is possible to use any kind of filter processing which allows to change at least one of correction processing and correction strength and can remove high-frequency noise. For example, it is possible to use a median filter as a filter.

In step S602, the noise removal unit 104 initializes the coordinate position (X, Y) indicating coordinates on the processing target image. In step S603, the noise removal unit 104 acquires a pixel value on the low-frequency image which corresponds to the coordinates (X, Y). In this case, the coordinates of each pixel of the low-frequency image are represented by (Xz, Yz). In addition, the coordinates of each pixel of the image to which dodging correction processing has been applied are represented by (Xw, Yw). In step S604, the noise removal unit 104 acquires a pixel value on the image after dodging correction which corresponds to the coordinates (X, Y).

In step S605, the noise removal unit 104 acquires a pixel value on the image, obtained by performing low-pass filter processing for the image having undergone dodging correction, which corresponds to the coordinates (X, Y). In this case, the coordinates of each pixel of the image after the low-pass filter processing are represented by (Xv, Yv). In step S606, the noise removal unit 104 calculates a difference value S between the pixel value after dodging correction, which corresponds the coordinates (X, Y), and the pixel value after the low-pass filter processing by using the following equation:

S(X,Y)=(C(Xw,Yw)−D(Xv,Yv)) (6)

In equation (6), C(Xw, Yw) represents a pixel value (0 to 255) of the image having undergone dodging correction at the coordinates (Xw, Yw), and D(Xv, Yv) represents a value (0 to 255) of the image, obtained by performing low-pass filter processing for the image having undergone dodging correction, at the coordinates (Xv, Yv). In this case, the difference value S will be described as a difference value for each color of R, G, and B. However, it is possible to use any value as long as it represents the density difference between pixels. For example, it is possible to convert R, G, and B components into luminance and color difference components and use the difference between only luminance components.

In step S607, the noise removal unit 104 acquires a pixel value at the coordinates (Xz, Yz) on the low-frequency image which correspond to the coordinates (X, Y) and calculates the emphasis coefficient K as in the processing by the dodging correction unit 103 described above. In step S608, the noise removal unit 104 performs noise removal by subtracting the value obtained by multiplying the difference value S by the emphasis coefficient K from the pixel value C(Xw, Yw) after dodging correction which corresponds the coordinates (X, Y). The following is an equation for noise removal:

N(X,Y)=C(Xw,Yw)−h×K×S(X,Y) (7)

In equation (7), N(X, Y) represents a pixel value (0 to 255 for each color of R, G, and B) after noise removal at the coordinates (X, Y), and h is a predetermined constant. The constant h may be defined empirically or in accordance with the emphasis coefficient K. Equation (7) indicates that the darker the low-frequency image, the higher the correction strength for noise removal, and vice verse.

When calculating a pixel value after noise removal, if the processing target image holds R, G, and B components, the noise removal unit 104 may multiply each of the R, G, and B components by the emphasis coefficient. For example, the noise removal unit 104 may convert R, G, and B components into luminance and color difference components (YCbCr) and multiply only the Y component by the emphasis coefficient. Performing the above processing for all the pixel values on the processing target image (S609 to S612) can perform noise removal processing using the low-frequency image. The printer 210 then prints the corrected image data on a printing medium.

With the above processing, the noise removal unit 104 can remove worsened dark region noise without affecting unnecessary regions irrelevant to the dark region noise by using a low-frequency image when determining a local control amount for dodging correction. In addition, even with regard to the processing in which the correction strength for dodging correction processing needs to be suppressed because of an increase in dark region noise, it is possible to increase the effect of dodging correction, because the correction strength can be increased.

(Features of Embodiment)

Even if, however, the correction amount for noise removal is controlled in accordance with the amount of dodging correction as noise removal processing by performing processing following the above procedure, since correction is performed only in the blurring direction (low-frequency direction), the overall image as the output result looks blurred.

A feature of this embodiment is therefore to reduce the sense of blurring of an overall image by using a low-frequency image and switching two types of filter processing, that is, noise removal processing and edge emphasis processing, based on the above processing procedure. The following description is about noise removal processing and edge emphasis processing performed in accordance with the amount of dodging correction using a low-frequency image by using a plurality of filters, which is a feature of the embodiment.

FIG. 7 is a block diagram for processing as a feature of this embodiment. FIG. 7 corresponds to FIG. 1 showing the basic arrangement. A processing procedure will be described with reference to FIG. 7. Processing in each processing unit will be described in detail with reference to a corresponding flowchart, as needed. Referring to FIG. 7, a filter processing unit 105 is a difference from FIG. 1. An image acquisition device 211, an exposure correctness determination unit 101, a low-frequency image generation unit 102, a dodging correction unit 103, and a printer 210 are the same as those in the first embodiment, and hence a detailed description of them will be omitted.

The filter processing unit 105 as a feature of this embodiment will be described in detail below. The filter processing unit 105 includes a plurality of filter processing modes, and changes the filter processing and correction strength in accordance with the amount of dodging correction using the above low-frequency image.

One of the plurality of filter processing modes uses a low-pass filter for reducing high-frequency components and a high-pass filter for emphasizing high-frequency components. In this embodiment, low-pass filter processing is 5×5 pixel average filter processing which can remove noise as fine variation components by smoothing. High-pass filter processing is unsharp mask processing which extracts high-frequency components by subtracting a smoothed image from an original image, and emphasizes the high-frequency components by adding them to the original image, thereby performing edge emphasis. Unsharp mask processing uses the result obtained by 5×5 pixel average filter processing used in low-pass filter processing.

Using the result obtained by average filter processing using the low-pass filter can implement low-pass filter processing and high-pass filter processing by only adding and subtracting the differences between the original image and the average filter processing result. This makes it possible to speed up the processing. In addition, since the single image obtained by the low-pass filter can be commonly used for the respective types of processing, it is possible to perform processing with efficient use of the memory. The filter processing unit 105 then changes the filter processing and correction strength for noise removal processing or edge emphasis processing with respect to the image having undergone dodging correction processing as an input image in accordance with the amount of dodging correction using the above low-frequency image.

(Filter Processing)

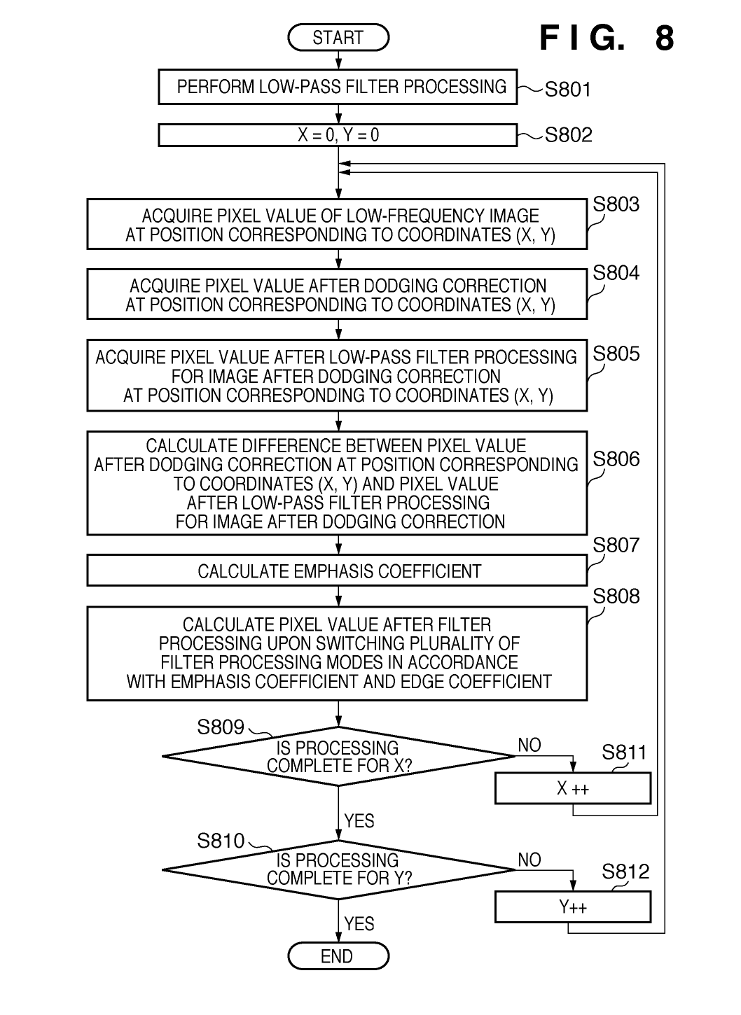

FIG. 8 is a flowchart for explaining processing in the filter processing unit 105 according to this embodiment. In the embodiment, this processing corresponds to FIG. 6 showing the basic processing procedure. The details of processing in steps S801 to S807 in FIG. 8 are the same as those in steps S601 to S607 in FIG. 6, and hence a description of the processing will be omitted. In addition, the details of processing in steps S809 to S812 in FIG. 8 are the same as those in steps S609 to S612 in FIG. 6, and hence a description of the processing will be omitted. The processing in step S808 will be described in detail below.

Step S808 will be described below with reference to FIG. 9. FIG. 9 is a graph for explaining a method of calculating an emphasis coefficient L for filter processing in this embodiment. Referring to FIG. 9, the abscissa represents the amount of dodging correction (0 to 255) using the above low-frequency image, and the ordinate represents the emphasis coefficient L (1.0 to −1.0) for filter processing. FIG. 9 indicates that the emphasis coefficient for filter processing changes on straight lines connecting a and b, and a and c with a change in the amount of dodging correction.

This embodiment uses a as a threshold. That is, if the amount of dodging correction is a to 255, the filter processing unit 105 switches filter processing modes so as to perform noise removal processing. If the amount of dodging correction is 0 to a, the filter processing unit 105 switches filter processing modes so as to perform edge emphasis processing. In addition, if the amount of dodging correction is a to 255, the contribution ratio (correction strength) of the low-pass filter for noise removal processing increases as the amount of dodging correction approaches 255. In contrast to this, if the amount of dodging correction is 0 to a, the contribution ratio (correction strength) of the high-pass filter for edge emphasis processing increases as the amount of dodging correction approaches 0. Assume that the threshold a is defined in advance. In this embodiment, the filter processing unit 105 performs noise removal processing by subtracting the value obtained by multiplying the difference value S by the emphasis coefficient L for filter processing from the pixel value C(Xw, Yw) after dodging correction which corresponds to the coordinates (X, Y). The following is an equation used for noise removal processing:

F(X,Y)=C(Xw,Yw)−h×L×S(X,Y) (8)

In equation (8), F(X, Y) represents a pixel value (0 to 255 for each color of R, G, and B) after noise removal or edge emphasis at the coordinates (X, Y), and h is a predetermined constant. The constant h may be defined empirically or in accordance with the emphasis coefficient L. In addition, since edge emphasis processing in this embodiment is unsharp mask processing, it is possible to perform edge emphasis by applying the calculated emphasis coefficient L for filter processing to equation (8).

It is possible to implement unsharp mask processing by adding the difference between each pixel value of an input image and a corresponding pixel value after low-pass filter processing to the corresponding value of the input image. It is therefore possible to implement noise removal processing by adding, instead of subtracting, the value obtained by multiplying the difference value S by the emphasis coefficient L for filter processing to the pixel value C(Xw, Yw) after dodging correction which corresponds to the coordinates (X, Y). Referring to FIG. 9, since the emphasis coefficient L has already been set to a coefficient of a negative value when the amount of dodging correction by edge emphasis is a to 255, using equation (8) without any change can also perform edge emphasis. Equation (8) therefore indicates that the darker a low-frequency image as a processing target, the higher the correction strength for noise removal, and vice versa.

Performing the above processing for all the pixel values on the output image (steps S809 to S812) can perform noise removal processing and edge emphasis processing in accordance with the amount of dodging correction using the low-frequency image. The printer 210 then prints the corrected image data on a printing medium. The above description concerns the block diagram for processing in this embodiment.

(Effect)

This embodiment can remove noise worsened by dodging correction processing. In addition, the embodiment can reduce the sense of blurring of an overall image by switching a plurality of filter processing modes using a low-frequency image and applying noise removal processing and edge emphasis processing to the image. Furthermore, since the embodiment performs noise removal processing and edge emphasis processing in accordance with the amount of dodging correction using a low-frequency image, it is possible to perform the processing without affecting regions which have not been corrected by dodging correction.

More specifically, this embodiment can remove dark region noise emphasized by dodging processing from a dark region in an image. In addition, the embodiment can reduce the sense of blurring of an overall image by performing edge emphasis for a bright region in an image and performing noise removal in a dark region. Conventionally, in noise removal processing and edge emphasis processing, filter processing for noise removal processing is performed first. Furthermore, although it is necessary to perform filter processing for edge emphasis processing for an image after noise removal processing, it is possible to switch noise removal processing and edge emphasis processing at the same time. This makes it possible to efficiently perform processing in terms of processing speed.

### Second Embodiment

The second embodiment of the present invention will be described below. According to the first embodiment, it is possible to properly remove dark region noise by locally changing the correction strength for dodging correction by using a low-frequency image and controlling the correction amount of noise removal in accordance with the amount of dodging correction. Even if, however, noise removal is performed by changing the filter processing and correction strength in accordance with the amount of dodging correction using a low-frequency image, when a dark region in which the amount of dodging correction is large includes an edge region which should not be blurred, the edge region is also blurred.

(Feature of Embodiment)

In order to solve the above problem, this embodiment performs edge determination for an image having undergone dodging correction while performing noise removal processing and controlling a control amount by using an edge determination result as well as the amount of dodging correction using a low-frequency image. An outline of an image processing system according to the embodiment will be described below with reference to the accompanying drawings.

(Explanation of Hardware Arrangement)

A hardware arrangement capable of executing the image processing method of the present invention is the same as that in the first embodiment shown in FIG. 2, and hence a description of the arrangement will be omitted.

(Explanation of Overall Processing Procedure)

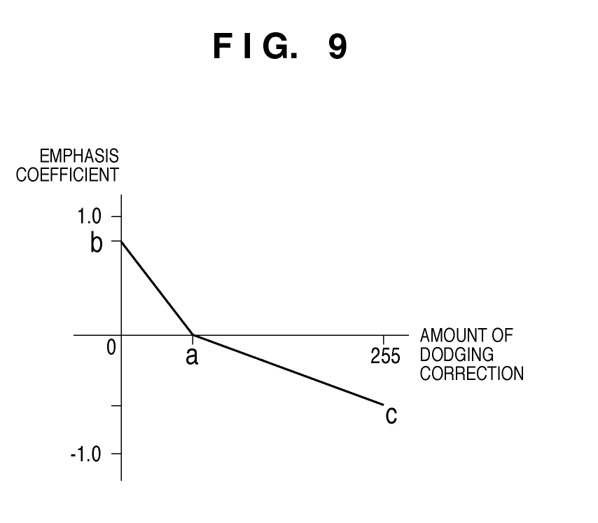

FIG. 10 is a block diagram showing processing in this embodiment. A processing procedure will be described below with reference to FIG. 10. Processing by each processing unit will be described in detail below with reference to a corresponding flowchart, as needed. Referring to FIG. 10, an image acquisition device 211, an exposure correctness determination unit 101, a low-frequency image generation unit 102, a dodging correction unit 103, and a printer 210 are the same as those in the first embodiment shown in FIG. 7, and hence a detailed description of them will be omitted.

First of all, the image acquisition device 211 acquires the digital image data which is captured by a digital camera and stored in a recording medium such as a memory card. The image acquisition device 211 then inputs the acquired digital image data as an input image to the exposure correctness determination unit 101. The exposure correctness determination unit 101 then performs exposure correctness determination by performing image analysis processing based on the input image data. If the exposure correctness determination unit 101 determines that the input image data is in a correct exposure state, this apparatus executes print processing through a general image processing procedure (not shown).

If the exposure correctness determination unit 101 determines that the input image data is an underexposure state, the low-frequency image generation unit 102 generates a low-frequency image first. The dodging correction unit 103 then performs processing. In addition, an edge determination unit 106 performs edge determination processing by using the image after dodging correction. A filter processing unit 105 then performs processing by using the low-frequency image and the edge determination amount. The low-frequency image generation unit 102 generates a plurality of blurred images with different degrees of blurring from the input image data, and generates a low-frequency image by compositing the plurality of blurred images. The dodging correction unit 103 then performs dodging correction processing for the input image from the low-frequency image.

The filter processing unit 105 and the edge determination unit 106 in this embodiment which differ from those in the first embodiment will be described in detail below. The edge determination unit 106 calculates an edge determination amount for each pixel by performing edge determination processing for the image after dodging correction. A storage unit such as a RAM 204 stores the calculated edge determination amount for each pixel. Note that various known references have disclosed edge determination processing, and it is possible to use any technique (a detailed description of it will be omitted).

(Edge Determination Processing)

The edge determination method in this embodiment extracts a luminance component from an image after dodging correction first. The method then calculates the average value of 3×3 pixels including a target pixel and the average value of 7×7 pixels including the target pixel. The method calculates the difference value (0 to 255) between the average value of the 3×3 pixels and the average value of the 7×7 pixels, and sets the difference value as an edge determination amount.

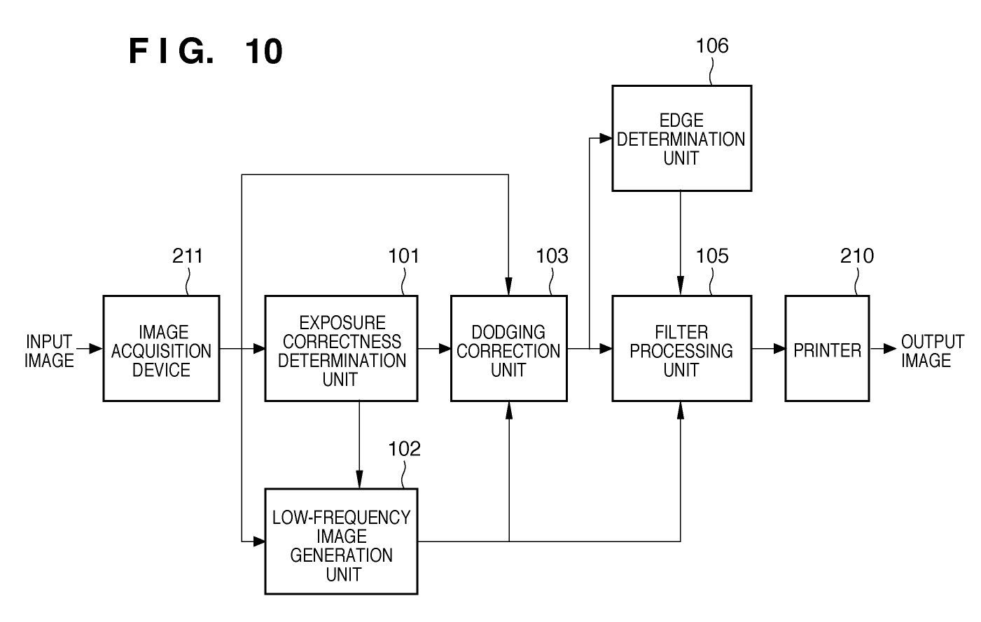

FIG. 11 is a view for explaining processing by the edge determination unit 106. Referring to FIG. 11, a luminance component is extracted from an image after dodging correction, and 9×9 pixels centered on a target pixel 1101 for which edge determination is performed are shown. When performing edge determination on the target pixel 1101 in the image after dodging correction, the edge determination unit 106 calculates the average value of a total of nine pixels in a 3×3 pixel region 1102 surrounded by a solid-line frame. The edge determination unit 106 also calculates the average value of a total of 49 pixels in a 7×7 pixel region 1103 surrounded by a solid-line frame. The edge determination unit 106 calculates the difference value (0 to 255) between the average value of the total of nine pixels in the 3×3 pixel region 1102 and the average value of the total of 49 pixels in the 7×7 pixel region 1103. The calculated difference value is set as an edge determination amount for the target pixel 1101.

As the edge determination amount approaches 0, the flatness increases. As the edge determination amount approaches 255, the flatness decreases, and the edge strength increases. This embodiment performs edge determination processing for an image after dodging correction. However, it is possible to perform edge determination processing for an input image or a low-frequency image.

(Noise Removal Processing)

The filter processing unit 105 includes a filter processing mode. The filter processing unit 105 changes the filter processing and correction strength in accordance with the amount of dodging correction using the above low-frequency image and the edge determination amount, sets the image after dodging correction as an input image, and performs noise removal processing.

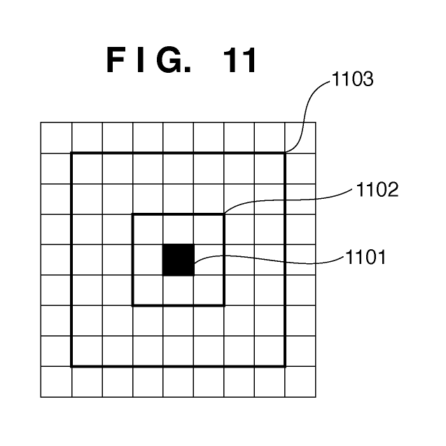

FIG. 12 is a flowchart for noise removal processing in this embodiment. The details of processing in steps S1201 to S1206 in FIG. 12 in the embodiment are the same as those in steps S801 to S806 in FIG. 8 described in the first embodiment, and hence a description of the processing will be omitted. The details of processing in steps S1211 to S1214 in FIG. 12 in the embodiment are the same as those in steps S809 to S812 in FIG. 8 described in the first embodiment, and hence a description of the processing will be omitted. The details of processing in steps S1207 to S1210, which are different from those in the first embodiment, will be described below.

In step S1207, the filter processing unit 105 acquires the pixel value at the coordinates (Xz, Yz) on the low-frequency image which correspond to the coordinates (X, Y) as in the processing by the dodging correction unit 103 described above, and calculates an emphasis coefficient J.

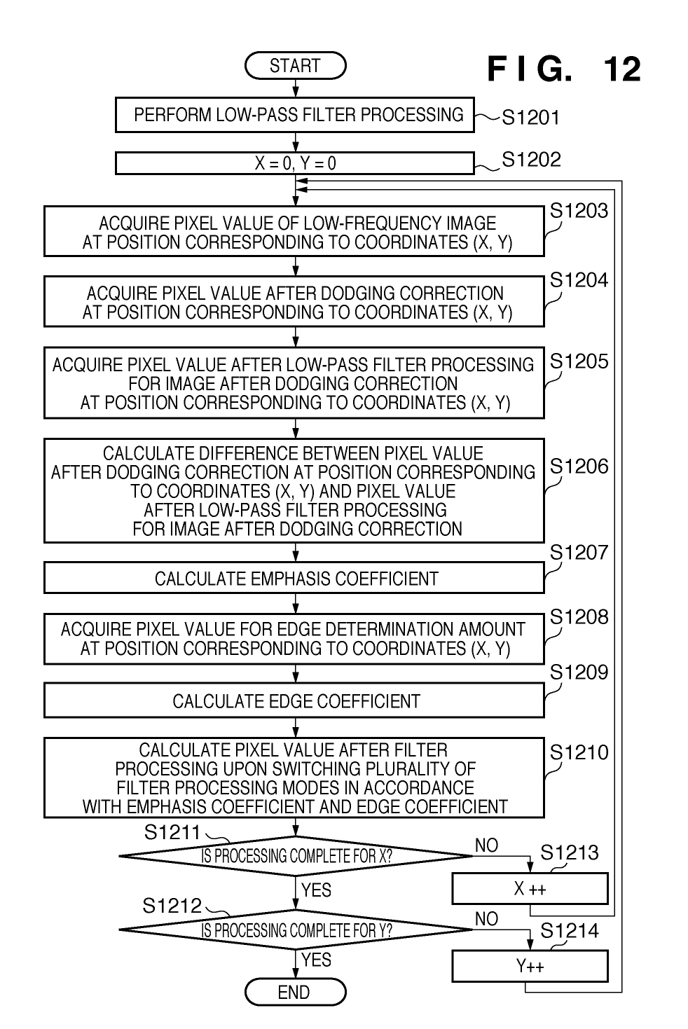

FIG. 13 is a graph for explaining the calculation of the emphasis coefficient J for filter processing in this embodiment. Referring to FIG. 13, the abscissa represents the acquired amount of dodging correction (0 to 255), and the ordinate represents the emphasis coefficient J (0 to 1.0). FIG. 13 indicates that the emphasis coefficient J changes on a straight line connecting a′ and b′ with a change in the amount of dodging correction. In this embodiment, as the amount of dodging correction approaches 255, the amount of correction made by dodging increases, whereas as the amount of dodging correction approaches 0, the amount of correction made by dodging decreases. Therefore, the larger the amount of dodging correction, the larger the emphasis coefficient J. In addition, assume that the value of a′ in the amount of dodging correction and the value of b′ in the emphasis coefficient J are defined in advance within the respective ranges of amounts of dodging correction and emphasis coefficients.

In step S1208, the filter processing unit 105 acquires an edge determination amount corresponding to the coordinates (X, Y) calculated by the edge determination unit 106. In step S1209, the filter processing unit 105 calculates a flatness coefficient M from the acquired edge determination amount.

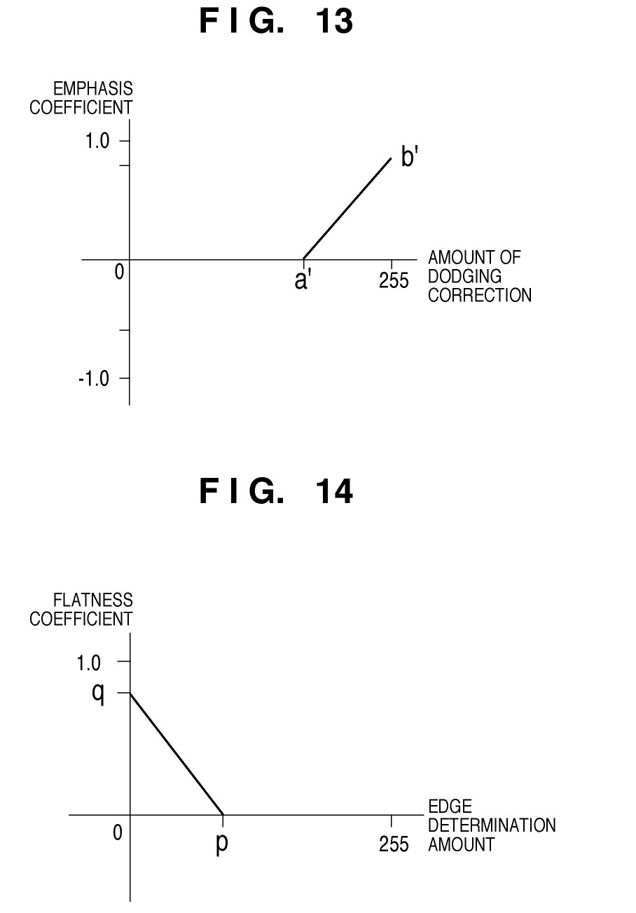

FIG. 14 is a graph for explaining the calculation of the flatness coefficient M in this embodiment. Referring to FIG. 14, the abscissa represents the acquired edge determination amount (0 to 255), and the ordinate represents the flatness coefficient M (1.0 to −1.0). FIG. 14 indicates that the flatness coefficient M changes on straight lines connecting p and q, and p and r with a change in edge determination amount. In this embodiment, p represents a threshold. The filter processing unit 105 switches the filter processing modes so as to perform noise removal processing if the edge determination amount is 0 to p and to perform edge emphasis processing if the edge determination amount is p to 255. In addition, if the edge determination amount is 0 to p, the contribution ratio (correction strength) of the low-pass filter increases for noise removal processing as the edge determination amount approaches 0. In contrast to this, if the edge determination amount is p to 255, the contribution ratio (correction strength) of the high-pass filter increases for edge emphasis processing as the edge determination amount approaches 255. Furthermore, assume that the value of p in the edge determination amount and the value of q in the flatness coefficient M are defined in advance within the respective ranges of edge determination amounts and flatness coefficients.

In step S1210, in noise removal processing, the filter processing unit 105 removes noise by subtracting the value obtained by multiplying the difference value S like that described in the first embodiment by the emphasis coefficient J for filter processing and the flatness coefficient M from a pixel value C(Xw, Yw) after dodging correction which corresponds to the coordinates (X, Y). The following is an equation used for noise removal:

F(X,Y)=C(Xw,Yw)−h×L×S(X,Y)×M (9)

In equation (9), F(X, Y) represents a pixel value (0 to 255 for each color of R, G, and B) after noise removal at the coordinates (X, Y), and h is a predetermined constant. The constant h may be defined empirically or in accordance with the emphasis coefficient J.

Performing the above processing for all the pixel values on the output image (steps S1211 to S1214) can perform noise removal processing and edge emphasis processing in accordance with the amount of dodging correction using the low-frequency image and the edge determination amount. The printer 210 then prints the corrected image data on a printing medium. The above description concerns the block diagram for processing in this embodiment.

(Effect)

Even if an edge portion exists in a dark region when noise removal is performed in accordance with the amount of dodging correction using a low-frequency image, this embodiment can remove noise without blurring the edge portion by using an edge determination amount as well as the amount of dodging correction. In addition, the embodiment performs processing in accordance with the influences of the amount of dodging correction using a low-frequency image and an edge determination amount when performing noise removal, and hence can remove worsened noise without affecting unnecessary regions irrelevant to noise and edges.

More specifically, this embodiment can remove noise worsened by dodging processing for a flat portion in a dark region by performing noise removal. In addition, with regard to an edge portion in the dark region, it is possible to remove noise without blurring the edge portion, which exists in the dark region and should not be blurred, by decreasing the amount of correction for noise removal as compared with a flat portion in the dark region and performing edge emphasis. In addition, with regard to regions other than noise worsened by dodging processing, since the strength of noise removal decreases, it is possible to process a flat region with gradual tones in the bright region without causing other troubles such as false contours.

### Third Embodiment

The third embodiment of the present invention will be described next. According to the second embodiment, using the amount of dodging correction using a low-frequency image and an edge determination amount can effectively perform noise removal. The noise removal method assumed in the second embodiment cannot remove low-frequency noise worsened by dodging processing because the method is designed to remove noise by blurring high-frequency noise using a low-pass filter or the like.

(Features of this Embodiment)

In order to solve the above problem, this embodiment uses filter processing for the removal of low-frequency noise as well as the processing described in the second embodiment in accordance with the amount of dodging correction using a low-frequency image and an edge determination amount. An outline of an image processing system according to the third embodiment will be described with reference to the accompanying drawings.

(Explanation of Hardware Arrangement)

A hardware arrangement which can execute the image processing method of the present invention is the same as that described with reference to FIG. 2, and hence a description of the arrangement will be omitted.

(Explanation of Overall Processing Procedure)

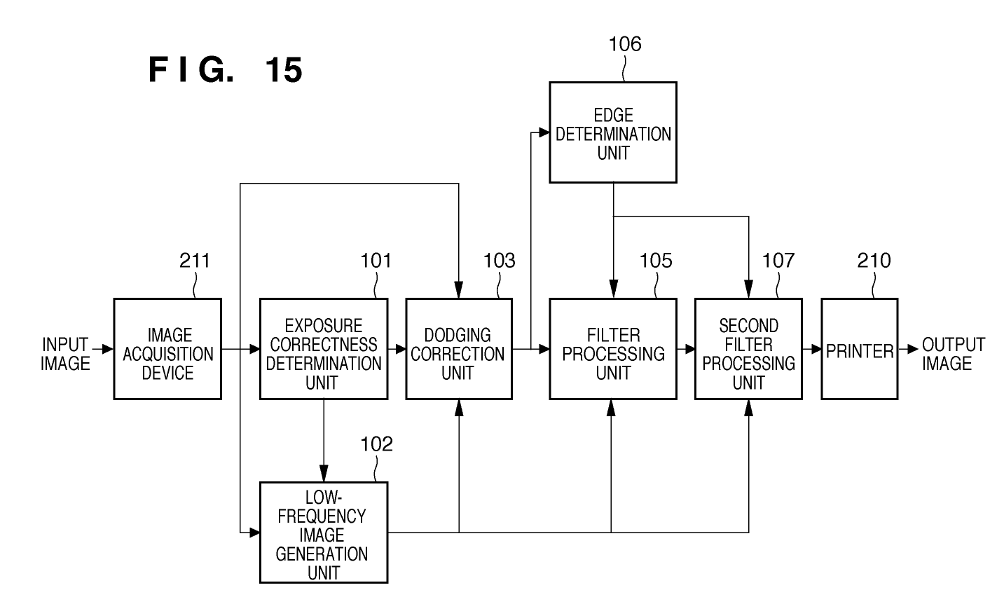

FIG. 15 is a block diagram for processing in this embodiment. A processing procedure will be described below with reference to FIG. 15. Processing by each processing unit will be described in detail with reference to a flowchart, as needed. Referring to FIG. 15, an image acquisition device 211, an exposure correctness determination unit 101, a low-frequency image generation unit 102, a dodging correction unit 103, a filter processing unit 105, an edge determination unit 106, and a printer 210 are the same as those in the second embodiment, and hence a description of them will be omitted.

First of all, the image acquisition device 211 acquires the digital image data captured by a digital camera and stored in a recording medium such as a memory card, and inputs the acquired digital image data as an input image to the exposure correctness determination unit 101. The exposure correctness determination unit 101 then performs image analysis processing from the input image data to perform exposure correctness determination. If the exposure correctness determination unit 101 determines that the input image data is in a correct exposure state, this apparatus executes print processing through a general processing procedure (not shown).

If the exposure correctness determination unit 101 determines that the input image data is in an underexposure state, the low-frequency image generation unit 102 generates a low-frequency image first, and the dodging correction unit 103 then performs processing. The edge determination unit 106 further performs edge determination processing by using the image after dodging correction. The filter processing unit 105 performs processing by using the low-frequency image and the edge determination amount. The low-frequency image generation unit 102 generates a plurality of blurred images with different degrees of blurring from the input image data, and generates a low-frequency image by compositing the plurality of generated blurred images. The dodging correction unit 103 performs dodging correction processing for the input image from the low-frequency image.

The edge determination unit 106 calculates an edge determination amount for each pixel by performing edge determination processing by using the image after dodging correction. A recording unit such as a RAM 204 stores the calculated edge determination amount for each pixel. The filter processing unit 105 then performs filter processing in accordance with the amount of dodging correction using the low-frequency image and the edge determination amount, and performs noise removal processing for the image after dodging correction as an input image upon changing the correction strength. A second filter processing unit 107 which performs processing following a procedure different from that in the second embodiment, which is a feature of the third embodiment, will be described in detail.

(Second Filter Processing)

The second filter processing unit 107 includes one or more filters, and performs the second filter processing for low-frequency noise removal in accordance with the amount of dodging correction using a low-frequency image and an edge determination amount. In this embodiment, the second filter processing for low-frequency noise removal will be described in target pixel/neighboring pixel replace processing (shuffling processing). Various known references have disclosed filter processing methods for low-frequency noise removal. In this case, the technique to be used is not specifically limited (a detailed description of the method will be omitted).

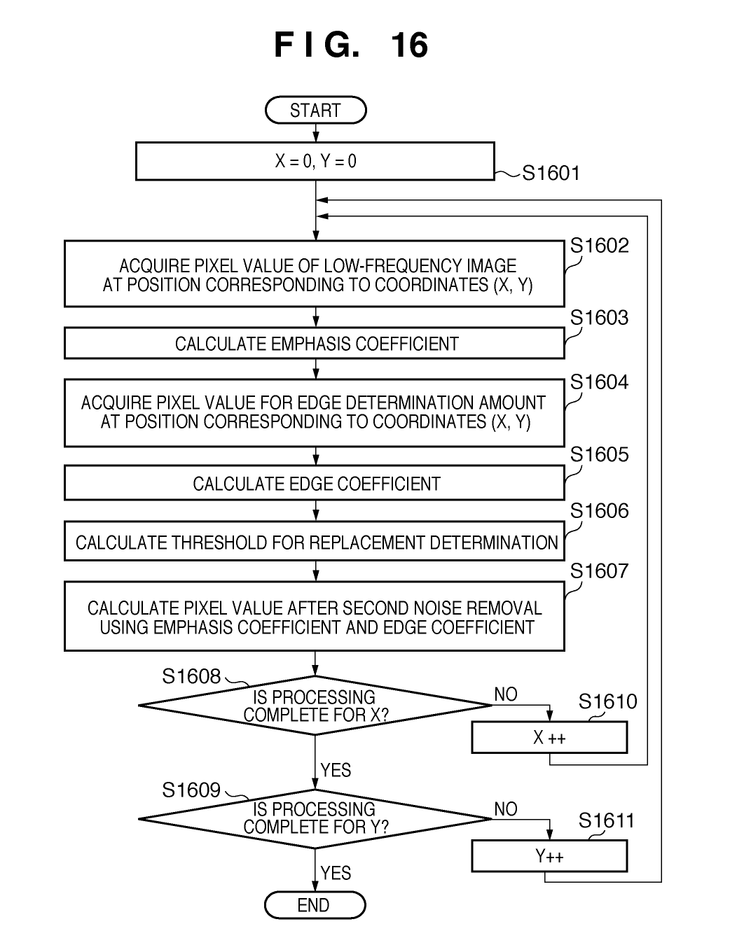

FIG. 16 is a flowchart for noise removal processing in this embodiment. The details of processing in steps S1601 to S1605 in FIG. 16 are the same as those in steps S1202, S1203, and S1207 to S1209 in FIG. 12 described in the second embodiment, and hence a description of the processing will be omitted. The details of processing in steps S1608 to S1611 in FIG. 16 are the same as those in steps S1211 to S1214 in FIG. 12 described in the second embodiment, and hence a description of the processing will be omitted. Processing in steps S1606 and S1607 which is different from that in the second embodiment will be described in detail below.

In step S1606, the second filter processing unit 107 calculates a threshold TH by using an emphasis coefficient K for dodging processing and a flatness coefficient M calculated from an edge determination amount. The threshold TH represents a threshold for determining whether to replace pixels in shuffling processing performed in noise removal processing of the second filter processing which is performed for low-frequency noise removal. Calculating the threshold TH from, for example, the value obtained by multiplying the emphasis coefficient K and the flatness coefficient M indicated in equation (10) given below allows to perform low-frequency noise removal processing in consideration of the correction strength for dodging correction and the flatness strength of an edge.

TH=t×K×M (10)

In equation (10), t is a constant, which is defined in advance. It is possible to change the constant t in accordance with the emphasis coefficient K and the flatness coefficient M. Equation (10) indicates that as the image becomes darker and flatter, the threshold TH increases, whereas as the image becomes brighter and the edge degree increases, the threshold TH decreases.

In step S1607, the second filter processing unit 107 randomly acquires a neighboring pixel within a predetermined region and determines whether a difference T between the target pixel and the neighboring pixel exceeds the threshold TH. If the difference T exceeds the threshold TH, the second filter processing unit 107 does not perform replace processing. If the difference T does not exceed the threshold TH, the second filter processing unit 107 performs replace processing between the target pixel and the randomly acquired neighboring pixel value.

Pixel replace processing in this embodiment will be described with reference to FIG. 17. Referring to FIG. 17, this apparatus sets a predetermined replacement range centered on a target pixel 1701 to a solid-line frame 1702 of 7×7 pixels. The apparatus then randomly selects a pixel from 48 pixels other than the target pixel in the solid-line frame 1702. Assume that the randomly selected pixel is a selected pixel 1703. In this case, the apparatus calculates the difference between the target pixel 1701 and the selected pixel 1703.

The apparatus then compares the threshold TH calculated from the emphasis coefficient K and flatness coefficient M of the target pixel with the difference between the target pixel 1701 and the selected pixel 1703. If the difference exceeds the threshold TH, the apparatus does not replace the pixel. If the difference does not exceed the threshold TH, the apparatus sets the pixel value of the selected pixel 1703 to the value of the target pixel 1701, and sets the pixel value of the target pixel 1701 to the pixel value of the selected pixel 1703, thereby replacing the pixel.

In equation (10), the threshold TH is set by only multiplying t as a predetermined constant by the emphasis coefficient K and the flatness coefficient M. However, the equation to be used to calculate the threshold TH is not limited to this. For example, since low-frequency noise tends to occur in a pixel array structure with little tone difference like an image of a blue sky, the emphasis coefficient K indicating contrast is set to a high value for a region with some degree of brightness. In contrast to this, it is assumed that replace processing for an edge portion like a line will cause a trouble that the line will break. If, therefore, a given portion is likely to be an edge, the flatness coefficient may be set to a lower value. In this embodiment, a pixel is randomly selected for replace processing. However, the present invention is not limited to this. For example, it is possible to perform replacement for, for example, a designated position in a predetermined region. In addition, the replacement range shown in FIG. 17 is not limited to a 7×7 pixel range, and may be changed in accordance with the characteristics of the image.

Performing the above processing for the pixel values on an output image (steps S1608 to S1611) can perform the second filter processing for a countermeasure against low-frequency noise, which uses a low-frequency image and an edge determination amount. The printer 210 then prints the corrected image data on a printing medium. The above description concerns the block diagram for processing in this embodiment.

This embodiment also uses a low-pass filter using an average filter for the second filter processing for noise removal and a high-pass filter using unsharp mask processing for edge emphasis. It is however possible to use any methods as long as they are for known noise removal processing and edge emphasis processing (a detailed description of them will be omitted). For example, a low-pass filter for noise removal processing may be filter processing which can reduce high-frequency components by smoothing processing, such as a median filter or Gaussian filter. A high-pass filter for edge emphasis processing may be filter processing which can emphasize high-frequency components by sharpening, such as a gradient filter or Laplacian filter.

In addition, this embodiment performs noise removal processing and edge emphasis processing for an image after dodging correction processing. However, it is possible to perform noise removal processing and edge emphasis processing for an image before dodging correction processing by using a low-frequency image.

(Effect)

This embodiment can remove high-frequency noise and low-frequency noise, which are worsened by dodging, by using a low-frequency image and an edge determination result when determining a local control amount for dodging correction. More specifically, noise in a captured dark portion is high-frequency noise such as spike noise, that is, local tone differences between neighboring pixels, it is possible to remove the noise by using a low-pass filter. In this case, when high-frequency noise can be removed, low-frequency noise worsened by dodging processing becomes visually noticeable. In this case as well, the image can be improved by performing low-frequency noise removal processing.

Furthermore, since correction strength for dodging correction and flatness strength for edges are taken into consideration, it is possible to remove worsened noise without affecting unnecessary regions irrelevant to noise and edges.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-118773, filed May 24, 2010, which is hereby incorporated by reference herein in its entirety.

What is claimed is:

1. An image processing apparatus comprising:
a determination unit which determines whether exposure of an input image is correct;
a generation unit which generates a low-frequency image for locally changing a correction amount of brightness for the input image when said determination unit determines that the exposure of the input image is incorrect;
a correction unit which corrects brightness of the input image by using the low-frequency image;
a holding unit which holds a plurality of filters including at least a low-pass filter and a high-pass filter; and
a filter processing unit which performs filter processing for a target pixel of an image corrected by said correction unit while locally changing at least types of the plurality of filters or a correction strength based on a correction amount of brightness using the low-frequency image,
wherein said filter processing unit increases correction strength of the low-pass filter in the filter processing as the correction amount of brightness for the target pixel by said correction unit increases, and increases correction strength of the high-pass filter in the filter processing as the correction amount of brightness for the target pixel by said correction unit decreases.

2. An image processing apparatus comprising:
a determination unit which determines whether exposure of an input image is correct;
a generation unit which a low-frequency image for locally changing a correction amount of brightness for the input image when said determination unit determines that the exposure of the input image is incorrect;
a correction unit which corrects brightness of the input image by using the low-frequency image;
an edge determination unit which detects an edge determination amount indicating a strength of an edge in one of the input image and an image whose brightness has been corrected by said correction unit;
a holding unit which holds a plurality of filters including at least a low-pass filter and a high-pass filter; and
a filter processing unit which performs filter processing for a target pixel of an image corrected by said correction unit while locally changing at least types of the plurality of filters or a correction strength by using a correction amount of brightness using the low-frequency image and the edge determination amount,
wherein said filter processing unit increases correction strength of the low-pass filter in the filter processing as the correction amount of brightness for the target pixel by said correction unit increases and the edge determination amount decreases, and increases correction strength of the high-pass filter in the filter processing as the correction amount of brightness for the target pixel by said correction unit increases and the edge determination amount increases.

3. The apparatus according to claim 1, wherein said determination unit detects a face region in the input image and determines correctness of exposure based on brightness of a pixel in the face region.

4. The apparatus according to claim 1, wherein the low-frequency image comprises an image obtained by compositing a plurality of low-frequency images with different cutoff frequencies.

5. The apparatus according to claim 1, wherein filter processing by the low-pass filter comprises filter processing of reducing a high-frequency component by using at least one of an average filter, a median filter, and a Gaussian filter.

6. The apparatus according to claim 1, wherein filter processing by the high-pass filter comprises filter processing of emphasizing a high-frequency component by using at least one of an unsharp mask, a gradient filter, and a Laplacian filter.

7. The apparatus according to claim 2, further comprising a replace unit which replaces a target pixel of an image having undergone filter processing by said filter processing unit with a neighboring pixel of the target pixel by using the correction amount of brightness by the low-frequency image and the edge determination amount.

8. The apparatus according to claim 7, wherein a threshold is calculated for each pixel by using the correction amount of brightness by the low-frequency image and the edge determination amount, the replace processing is performed when a difference between the target pixel and the neighboring pixel does not exceed the threshold, and the replace processing is not performed when the difference exceeds the threshold.

9. The apparatus according to claim 1, further comprising a print unit which prints an image to which the filter processing is applied on a printing medium.

10. An image processing method comprising:
a determination step of causing a determination unit to determine whether exposure of an input image is correct;
a generation step of causing a generation unit to generate a low-frequency image for locally changing a correction amount of brightness for the input image when it is determined in the determination step that the exposure of the input image is incorrect;
a correction step of causing a correction unit to correct brightness of the input image by using the low-frequency image; and
a filter processing step of causing a filter processing unit to perform filter processing for a target pixel of an image corrected in the correction step while locally changing at least types of the plurality of filters including at least a low-pass filter and a high-pass filter or a correction strength based on a correction amount of brightness using the low-frequency image,
wherein in the filter processing step, a correction strength of the low-pass filter in the filter processing increases as the correction amount of brightness for the target pixel in the correction step increases, and a correction strength of the high-pass filter in the filter processing increases as the correction amount of brightness for the target pixel in the correction step decreases.

11. An image processing method comprising:
a determination step of causing a determination unit to determine whether exposure of an input image is correct;
a generation step of causing a generation unit to generate a low-frequency image for locally changing a correction amount of brightness for the input image when it is determined in the determination step that the exposure of the input image is incorrect;
a correction step of causing a correction unit to correct brightness of the input image by using the low-frequency image;
an edge determination step of causing an edge determination unit to detect an edge determination amount indicating a strength of an edge in one of the input image and an image whose brightness has been corrected in the correction step; and
a filter processing step of causing a filter processing unit to perform filter processing for a target pixel of an image corrected in the correction step while locally changing at least types of the plurality of filters including at least a low-pass filter and a high-pass filter or a correction strength by using a correction amount of brightness using the low-frequency image and the edge determination amount,
wherein in the filter processing step, a correction strength of the low-pass filter in the filter processing increases as the correction amount of brightness for the target pixel in the correction step increases and the edge determination amount decreases, and a correction strength of the high-pass filter in the filter processing increases as the correction amount of brightness for the target pixel in the correction step increases and the edge determination amount increases.

12. A computer-readable medium storing a program for causing a computer to function as an image processing apparatus defined in claim 1.
